(19) United States
(12) Patent Application Publication
(10) Pub. No.: US 2025/0372000 A1
(43) Pub. Date: Dec. 4, 2025

(54) SYSTEM AND METHOD FOR SIMULATING FLUID FLOW

(71) Applicant: FLIGHTSAFETY INTERNATIONAL, Columbus, OH (US)

(72) Inventors: Bradley TORGLER, Overland Park, KS (US); Nicholas HALL, Windsor, CA (US); Terry TYLER, Tulsa, OK (US); Ryan RUPE,, Broken Arrow, OK (US)

(21) Appl. No.: 19/108,161

(22) PCT Filed: Sep. 2, 2022
(86) PCT No.: PCT/US2022/042489

§ 371 Date: Mar. 1, 2025

(51) Int. Cl. G09B 23/12; G06F 30/28; G09B 9/02

(52) U.S. Cl. CPC G09B 23/12; G06F 30/28; G09B 9/02

(57) ABSTRACT

A computer-implemented method for determining interference effects on atmospheric fluid flow during a real-time simulation due to terrain and obstacles to produce varying localized flow disturbances is described. These interference effects may be applied to a simulated vehicle dynamic model and updated in real-time to provide feedback resulting from the interaction of the vehicle with the flow fields.

### FIELD OF THE INVENTION

This disclosure generally relates to the field of fluid flow simulation, and more particularly, to simulation of perturbation of the flow of a fluid due to the proximity of terrain or obstacles for a real-time vehicle simulator.

### BACKGROUND

The efficient design and safe operation of vehicles functioning in moving fluids, such as aircraft surrounded by air and submarines surrounded by water, requires an extensive amount of costly testing and training. While physical testing apparatuses such as wind tunnels may provide some degree of feedback for the design of such vehicles, the operation of these apparatuses is expensive and limited in that they cannot provide a wide range of testing conditions.

Simulators have been developed that dramatically reduce the cost of testing and may provide a variety of conditions and environments, thus allowing vehicle operators to train in such diverse conditions and environments and react to changing conditions and circumstances while providing feedback to the operator. Typically, the operator of a simulator may observe terrain and obstacles on a visual device and pilot the vehicle in the environment, with feedback to the operator accounting for the operator's input in controlling the vehicle and effects of the fluid in the environment on the vehicle, which may be affected by the terrain, obstacles, and the vehicle itself. The terrain and obstacles may be typically created with elements stored in databases containing topographies and physical objects, such as buildings, trees, etc.

A primary challenge of creating an accurate simulation is the interaction between the vehicle and the environment, including weather, turbulence, and the accurately simulated flow of fluid over and around terrain and obstacles. The interaction of the fluid with weather conditions and the terrain and obstacles in the simulated environment may be generated by pre-calculating flow and turbulence fields around the simulated terrain and obstacles in the database using computational fluid dynamics (CFD). Generating the simulated fluid flow interacting with a simulated environment requires extensive computational resources, which results in either low fidelity simulations to compensate for the computational resources available or high cost to account for the computational resources required for a high fidelity, precise simulation.

As a result of pre-calculating flow and turbulence fields, such CFD simulations may be also limited in that they only update in real-time over a short loop within a specified visual gaming area using look-up tables for simulator application, which does not allow for accurate real-time feedback to the operator of the simulator over the entire simulated visual environment as a result of inputs or changing conditions during the simulation.

Accordingly, more efficient and cost-effective systems and methods of making and using computational fluid dynamics for vehicle simulation may be desirable.

### BRIEF SUMMARY

The present disclosure relates to efficient and cost-effective systems and computational methods for real-time simulation of the flow of an atmospheric fluid due to the proximity of terrain or obstacles. Such systems and methods may be implemented for use in a vehicle simulator to provide real-time training for vehicle operation under conditions of varying localized fluid flow and disturbances.

Accordingly, the present disclosure provides a method for determining interference effects on a fluid caused by a simulated terrain profile and experienced by a simulated vehicle in real-time. The method generally comprises receiving a freestream direction and a freestream speed for a simulated freestream of the fluid, receiving a two-dimensional simulated geometric terrain profile along the freestream direction having a horizontal x-axis and a vertical z-axis, packing a number of geometric cylinders representing doublets in the vertical z-axis along the horizontal x-axis under the two-dimensional simulated geometric terrain profile, determining an analysis point having an analysis x and analysis z position for a simulated vehicle relative to a reference position of the simulated vehicle using a defined x offset and z offset reference and an angular pitch attitude of the simulated vehicle relative to the freestream direction passing through the reference position, determining a flowfield fluid perturbation ratio at the analysis point along the x-axis and the z-axis, determining flow behavior conditions around the simulated vehicle and a positioning of the simulated vehicle relative to the simulated geometric terrain profile based on the flowfield fluid perturbation ratios, determining flowfield fluid perturbation ratio gains based on the positioning of the simulated vehicle relative to the simulated geometric terrain profile, determining a total planar fluid velocity comprising the freestream speed and flowfield fluid perturbation ratios and gains along the freestream direction and a total vertical fluid velocity comprising the vertical flowfield fluid perturbation ratio and gain along the z-axis, and transforming the planar fluid velocity into two dimensions.

The methods may be implemented as software executable by a processor. Moreover, the software may be provided as part of a system, such as a simulator system comprising a processor, a non-transitory computer-readable storage medium, and instructions stored on the non-transitory computer-readable storage medium for execution of the method by the processor.

It is to be understood that both the foregoing summary and the following detailed description may be exemplary and may be not restrictive of the embodiments of the invention as claimed. Certain details may be set forth in order to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

### DESCRIPTION OF THE DRAWINGS

The present invention described herein may be better understood by reference to the accompanying drawing sheets, in which:

FIG. 1 depicts a flow chart of a computer-implemented method for determining interference effects on a fluid caused by a simulated terrain profile and experienced by a simulated vehicle in real-time.

FIG. 2 depicts a two-dimensional simulated geometric terrain profile packed with doublets.

FIG. 3 depicts a visual representation of a doublet in potential flow theory.

FIG. 4 depicts a two-dimensional simulated geometric terrain profile with obstacles packed with doublets and flow effects depicted by flow lines.

FIG. 5 depicts a method of emulating eddy vortex results.

FIG. 6 is a graph depicting terrain distance profile resolution varying with ground speed.

FIG. 7 depicts a shifted two-dimensional simulated geometric terrain profile of FIG. 2 with minimum elevation at zero for analysis purposes.

FIG. 8 depicts a flowchart of a process for packing a number of full-size doublets under the two-dimensional simulated geometric terrain profile.

FIG. 9 depicts a flowchart of a process for determining the intersecting slopes of each point on the x-axis of the simulated geometric terrain profile.

FIG. 10 depicts a flowchart of a process for determining the size and number of the smaller doublets to pack in any remaining space under the simulated terrain profile after it has been packed with full-size doublets.

FIG. 11 depicts a simulated geometric terrain profile packed with full-size doublets with any remaining space packed with smaller doublets.

FIG. 12A depicts a third-person perspective view of a simulated geometric terrain profile relative to a simulated vehicle according to some aspects.

FIG. 12B depicts a first-person view of a simulated geometric terrain relative to the simulated vehicle from the perspective of the simulated vehicle's cockpit according to some aspects.

FIG. 13 depicts a simulator for a simulated vehicle in a fluid with a simulated terrain according to some aspects.

FIG. 14 depicts a system for determining interference effects on a fluid caused by a simulated geometric terrain profile and experienced by a simulated vehicle in real-time.

### DETAILED DESCRIPTION

This disclosure generally describes systems and methods of making and using fluid perturbation software. It is understood, however, that this disclosure also embraces numerous alternative features, aspects, and advantages that may be accomplished by combining any of the various features, aspects, and/or advantages described herein in any combination or sub-combination that one of ordinary skill in the art may find useful. Such combinations or sub-combinations may be intended to be included within the scope of this disclosure. As such, the claims may be amended to recite any features, aspects, and advantages expressly or inherently described in, or otherwise expressly or inherently supported by, this disclosure. Further, any features, aspects, and advantages that may be present in the prior art may be affirmatively disclaimed. Accordingly, this disclosure may comprise, consist of, consist essentially of, or be characterized by one or more of the features, aspects, and advantages described herein.

Conventional methods of simulating fluid over terrain and obstacles for vehicle simulators making use of high-level solutions such as RANS CFD solvers provide only a limited area for a vehicle to traverse with time limited flow fields because the fluid analysis must be pre-calculated on servers over long periods of time before the simulation is used and often applied using look-up tables during the simulation. Because the fluid dynamics may be pre-calculated, changes in conditions and feedback to the fluid flow from the vehicle during the simulation may not be fully accounted for in real-time, resulting in less accurate feedback to an operator of the vehicle in a simulation.

The present invention may provide interference effects on atmospheric fluid flow during a real-time simulation due to terrain and obstacles to produce varying localized flow disturbances and applies those results to a simulated vehicle dynamic model during real-time execution. Therefore, the fluid simulation provided by the present invention is not limited to a specific pre-calculated area and time, as is true with conventional methods, and instead covers the entire simulation visual database independent of vehicle position and travel direction. The fluid flow fields may be also updated in real-time to provide feedback resulting from the interaction of the vehicle with the flow fields.

The real-time simulation of fluid flow fields according to methods of the present disclosure is accomplished using a simplified CFD approach known as potential flow theory. According to this theory, the flow is assumed to be inviscid and incompressible due to relatively low flow velocity of the fluid. Flow variations (i.e., perturbations) due to terrain may be acquired by packing visually queried two-dimensional (2-D) terrain profiles with doublets (flow theory source and sink). Doublet flow is a term in fluid dynamics that describes the fluid flow that is achieved when a source and sink may be placed close together. A point is a source if an object placed near it would flow directly away from that point and a sink if an object placed near it would flow directly toward that point. The doublets may be positioned in the 2-D terrain profile to follow the fluid freestream direction and pass through the vehicle's reference position. In simulation systems, such a vehicle is referred to as one's ownship, i.e., one's own vehicle or aircraft.

Extracting and applying disturbance effects due to terrain and obstacle interference provides more accurate simulation, which improves simulator fidelity and realism. The system functionality disclosed herein may deliver realistic swells for updrafts and downdrafts defining the line of demarcation, leeward-side flow blockage effects, eddy characteristic impacts on motion feel and behavior, and flow accelerations coming over the topsides of terrain and objects. Thus, the methods disclosed herein improve simulation training because they accurately influence dynamic performance and required handling qualities to ensure safe control of a simulated vehicle.

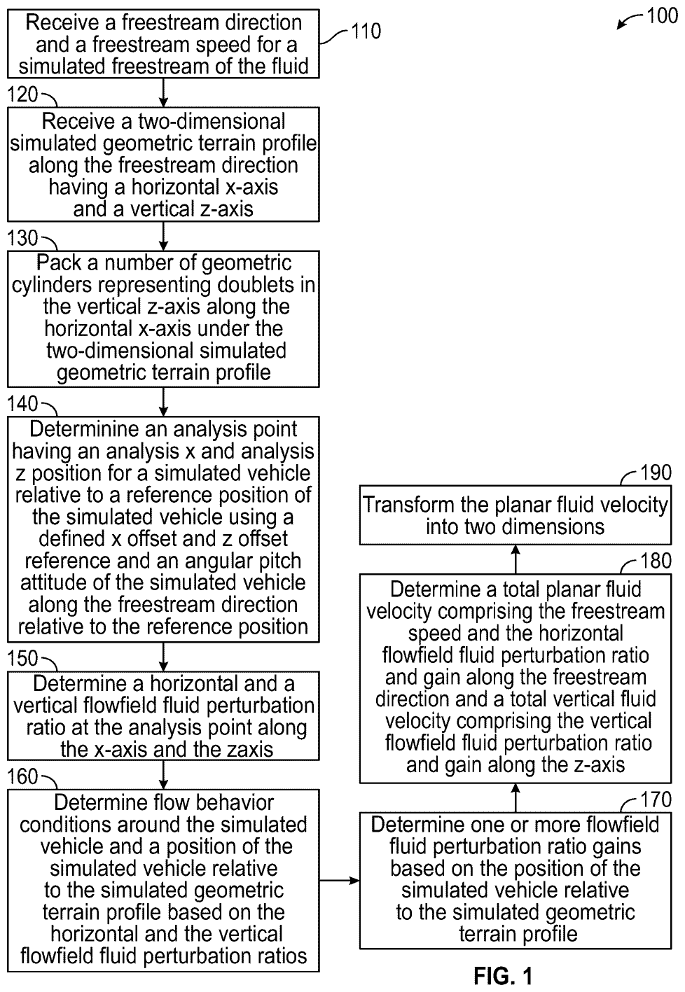

FIG. 1 depicts a flow chart of a computer-implemented method 100 for determining interference effects on an atmospheric fluid caused by a simulated terrain profile and experienced by a simulated vehicle in real-time. The method 100 is performed by a computer machine provided with a processing unit and a memory.

The method begins at 110 by acquiring a freestream direction and a freestream speed for a simulated freestream of the fluid. The freestream represents steady fluid movement without any turbulence or gusts. According to some aspects, the freestream direction and the freestream speed may be stored in the memory of the computer and may be acquired from actual data, data input by the user, i.e., operator, or by an instructor during a training exercise using the disclosed software and systems. The data input by the user or operator may be freeform or may be selection from a set of preset options, e.g., preset speeds and wind directions.

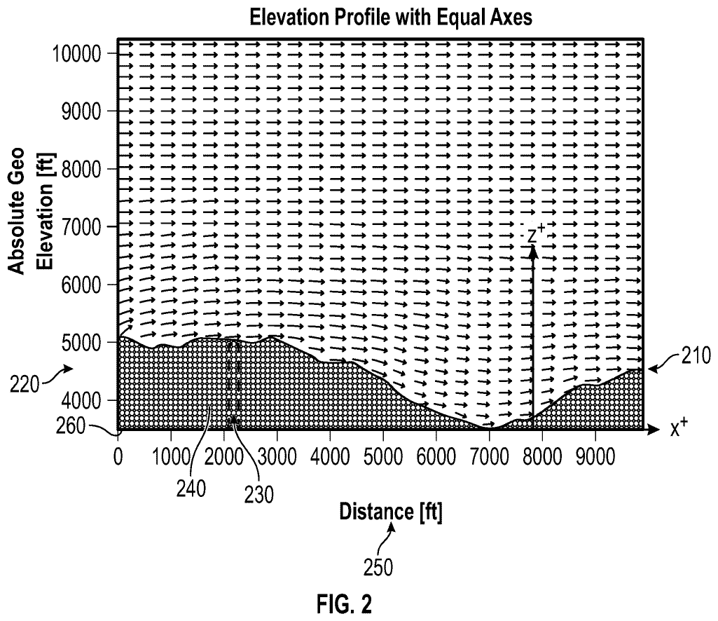

At 120, a two-dimensional simulated geometric terrain profile 210 along the freestream direction having a horizontal x-axis and a vertical z-axis, as depicted in FIG. 2, is received. According to some aspects, the simulated geometric terrain profile 210 is received in real-time and stored in the memory of the computer machine. According to some aspects, the terrain profile 210 is provided relative to a reference position of the simulated vehicle, with the simulated vehicle at a zero x-position, wherein ascending positive x values on one side of the simulated vehicle and descending negative x values away from the vehicle in the opposite direction. According to some aspects, the positive x values may be on the downstream side of the freestream direction and the negative x values may be on the upstream side of the freestream direction, although other aspects may define the x values in the opposite direction. The terrain profile has z values initially defined as an absolute geographic elevation 220. An amount of terrain captured upstream is a preset input for the model. According to some aspects, the amount of terrain captured upstream may be changed by any training device manufacturer (TDM). According to a preferred aspect, 80% of the terrain is upstream and 20% is downstream.

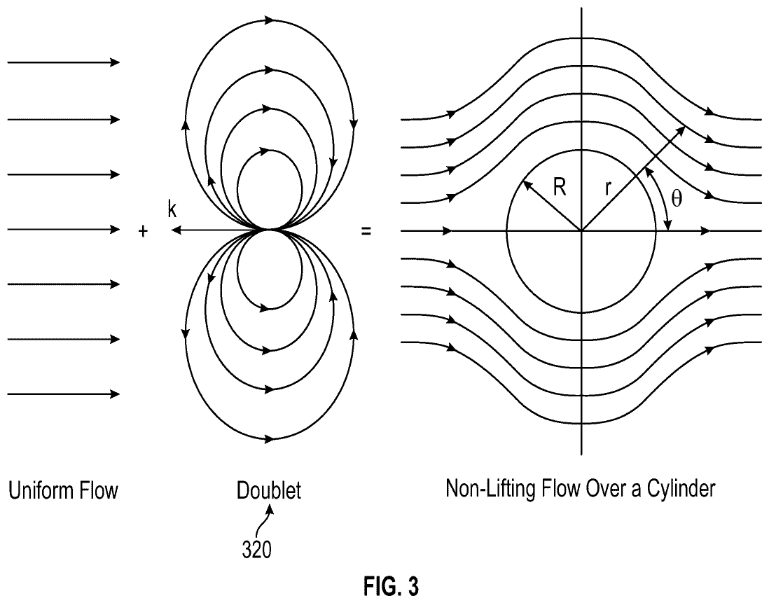

At 130, a number of geometric cylinders 230 representing a number of doublets 240 in the vertical z-axis along the horizontal x-axis under the two-dimensional simulated terrain profile 210, as depicted in FIG. 2. A visual representation of the doublets 240 under potential flow theory is depicted in FIG. 3 at 320. As depicted in FIG. 2, a maximum number of doublets 240 may be packed under the terrain profile 240 as may fit by stacking the doublets 240 vertically as the geometric cylinders 230 to reach the terrain profile 210 at the top. The geometric cylinders 230 may be packed next to each other along the x-axis as closely as possible such that each geometric cylinder 230 touches the geometric cylinders 230 next to it on the x-axis.

At 140, an analysis point is determined having an analysis x and an analysis z position for a simulated vehicle relative to a reference position of the simulated vehicle using defined x offset and z offset references and an angular pitch attitude of the simulated vehicle along the freestream direction relative to the reference position. The x offset and the z offset may be preset inputs to the model and may be defined relative to a reference position of the simulated vehicle. The reference position of the simulated vehicle is located at an x position of x=0. According to some aspects, the TDM may change the offset values, which may be likely to vary for different simulated vehicles. Calculations for the analysis x and the analysis z positions may be given as:

$${x}^{′} = {x}_{offset} * cos ( {θ}^{′} ) + {z}_{offset} * sin ( {θ}^{′} )$$

$${z}^{′} = {h}_{geo} - {x}_{offset} * sin ( {θ}^{′} ) + {z}_{offset} * cos ( {θ}^{′} ) - {z}_{shift}$$

### Where:

h_{geo} is the geometric altitude of the reference position of the simulated vehicle in the same units as the terrain profile,
θ′ is the simulated ownship angular pitch attitude along the freestream direction,
z_{shift} is any shift to the terrain profile, if one has been applied.

According to some aspects, a distance from the analysis point to each doublet center is determined. The distance from the analysis point to each doublet center may be used to prevent further integration analysis if the simulated vehicle ventures into any doublet. According to some aspects, this is accomplished by performing an analysis loop is performed through every doublet using each doublet's stored radius (Rᵢ) and center position (xᵢ, zᵢ) stored within their respective geometry arrays. The analysis position is checked relative to revery doublet and triggers the analysis loop to halt if within any doublet. This process prevents erroneous results, which may be yielded by potential flow theory calculations when analyzing within a doublet. The analysis is performed by the following equation, which triggers the analysis loop to halt if the condition is met:

$$\sqrt{{( {x}^{′} - {x}_{i} )}^{2} - {( {z}^{′} - {z}_{i} )}^{2}} \leq {R}_{i}$$

### Where:

(Rᵢ) is the radius of the analyzed doublet

(xᵢ, zᵢ) is the x and y coordinates of the center of the analyzed doublet

At 150, a horizontal (u) and a vertical (w) flowfield fluid perturbation ratio at the analysis point may be determined along the x-axis and the z-axis, respectively. Potential flow theory is used to determine the horizontal (u) and vertical (w) fluid perturbation ratios to describe a local fluid flow at the analysis point according to the following equations:

$$ψ ( {x}^{′} , {z}^{′} ) = {v}_{∞} {z}^{′} - {v}_{∞} ε$$

$$ψ ( {x}^{′} , {z}^{′} ) = {v}_{∞} [ {z}^{′} - {\sum }_{i = 1}^{n} {R}_{i}^{2} \frac{( {z}^{′} - {z}_{i} )}{{( {x}^{′} - {x}_{i} )}^{2} + {( {z}^{′} - {z}_{i} )}^{2}} ]$$

$$ε ( {x}^{′} , {z}^{′} ) = {\sum }_{i = 1}^{n} {R}_{i}^{2} \frac{( {z}^{′} - {z}_{i} )}{{( {x}^{′} - {x}_{i} )}^{2} + {( {z}^{′} - {z}_{i} )}^{2}}$$

$$u ( {x}^{′} , {z}^{′} ) = \frac{\partial ψ}{\partial {z}^{′}} = {v}_{∞} [ 1 - \frac{\partial ε}{\partial {z}^{′}} ] = {v}_{∞} [ 1 - {\sum }_{i = 1}^{n} {R}_{i}^{2} \frac{{( {x}^{′} - {x}_{i} )}^{2} - ( {z}^{′} - {z}_{i} )}{{( {( {x}^{′} - {x}_{i} )}^{2} + {( {z}^{′} - {z}_{i} )}^{2} )}^{2}} ] = {v}_{∞} [ 1 - du ]$$

$$w ( {x}^{′} , {z}^{′} ) = - \frac{\partial ψ}{\partial {x}^{′}} = {v}_{∞} [ \frac{\partial ε}{\partial {x}^{′}} ] = {v}_{∞} {\sum }_{i = 1}^{n} - 2 {R}_{i}^{2} \frac{( x - {x}_{i} ) ( z - {z}_{i} )}{{( {( x - {x}_{i} )}^{2} + {( z - {z}_{i} )}^{2} )}^{2}} = {v}_{∞} [ dw ]$$

$$du ( {x}^{′} , {z}^{′} ) = {\sum }_{i = 1}^{n} {R}_{i}^{2} \frac{{( {x}^{′} - {x}_{i} )}^{2} - ( {z}^{′} - {z}_{i} )}{{( {( {x}^{′} - {x}_{i} )}^{2} + {( {z}^{′} - {z}_{i} )}^{2} )}^{2}}$$

$$dw ( {x}^{′} , {z}^{′} ) = {\sum }_{i = 1}^{n} - 2 {R}_{i}^{2} \frac{( {x}^{′} - {x}_{i} ) ( {z}^{′} - {z}_{i} )}{{( {( {x}^{′} - {x}_{i} )}^{2} + {( {z}^{′} - {z}_{i} )}^{2} )}^{2}}$$

### Where:

| | |
|---|---|
| ψ | Streamline Function |
| v_{∞} | Uniform freestream velocity |
| Rᵢ | Radius of analyzed doublet |
| xᵢ | X-coordinate center of analyzed doublet |
| zᵢ | Z-coordinate center of analyzed doublet |
| x′ | Analysis x-coordinate |
| z′ | Analysis z-coordinate |
| ε | Summation part of the Streamline Function |
| n | Total number of packed doublets |
| i | Doublet index counter |
| u | Horizontal component (x) of flow velocity in the flow direction |
| | reference frame |
| w | Vertical component (z) of flow velocity in the flow direction |
| | reference frame |
| du | Horizontal component flow perturbation ratio |
| dw | Vertical component flow perturbation ratio |

At 160, a set of flow behavior conditions around the simulated vehicle and a position of the simulated vehicle relative to the simulated geometric terrain profile 210 may be determined based on the horizontal (u) and vertical (w) flowfield fluid perturbation ratios. Specifically, a frontside, a topside, and a backside of the simulated vehicle may be determined, as well as a number of flow conditions, such as blockage, acceleration, upwash, and downwash, based on the calculated perturbation ratios. According to some aspects, only perturbation ratios beyond a defined threshold may be considered. The position of the simulated vehicle relative to the terrain profile 210 and the flow behavior may be determined according to the following:

$$Downwash \to dw < - {dw}_{threshold}$$

$$Upwash \to dw > + {dw}_{threshold}$$

$$Acceleration \to du < - {du}_{threshold}$$

$$Blockage \to du > + {du}_{threshold}$$

Topside→When Acceleration is true.
Backside→When Blockage is true and any portion of the terrain z values in the range of a defined number of x index points upstream of the reference position of the simulated vehicle, n_{pts_ahead}, is greater than the analysis z position, z′.
Frontside→When Blockage is true and Backside is false.
The threshold values (dw_{threshold}, du_{threshold}), and a number of index points ahead (n_{pts_ahead}) may be changed by a TDM. According to some preferred aspects, dw_{threshold}=0.001, du_{threshold}=0.01, and n_{pts_ahead}=10.

At 170, one or more flowfield perturbation ratio gains may be determined based on the position of the simulated vehicle relative to the simulated geometric terrain profile 210. To do so, the flow velocity equations may be adjusted to incorporate gains on the perturbation ratios according to the equations:

$$u ( {x}^{′} , {z}^{′} ) = {v}_{∞} [ 1 - {k}_{du} du ]$$

$$w ( {x}^{′} , {z}^{′} ) = {v}_{∞} [ {k}_{dw} dw ]$$

where k_{du} is the perturbation ratio gain for the horizontal component and k_{dw} is the perturbation ratio gain for the vertical component.

The gains may be set based on a location condition of the simulated vehicle and may be changed by a TDM. According to some preferred aspects, k_{du}=1.0 when at frontside or topside of the simulated vehicle and k_{du}=1.5 when at the backside of the simulated vehicle.

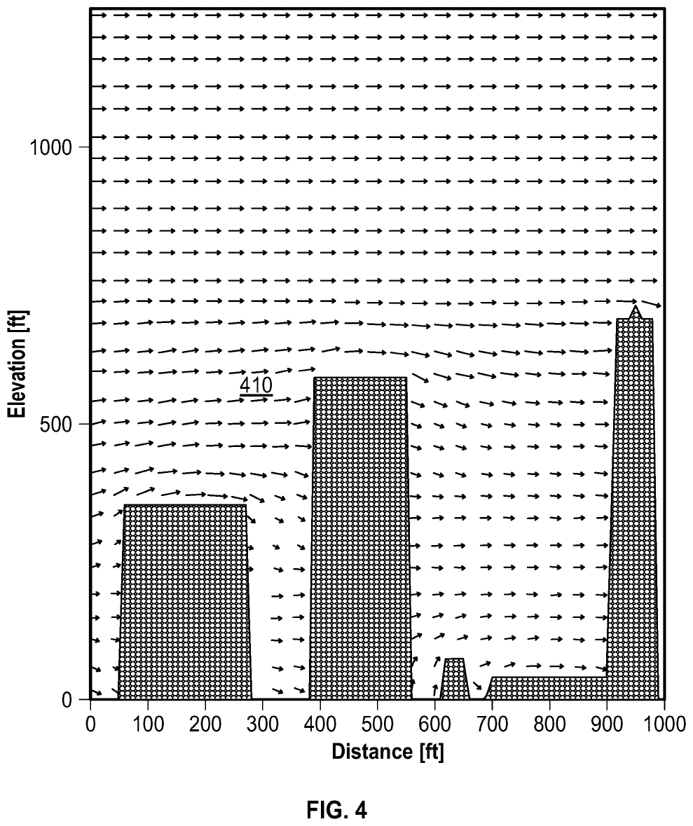

At 180, a total planar fluid velocity comprising the freestream speed and the horizontal flowfield fluid perturbation ratio and gain along the freestream direction, and a total vertical fluid velocity comprising the vertical flowfield fluid perturbation ratio and gain along the z-axis may be determined. The total planar fluid velocity along the freestream flow direction is given as u (x′, z′) and the vertical fluid velocity is given as w (x′, z′). The planar and vertical fluid velocities may be also planar and vertical, respectively, to Earth's axes, due to the terrain profile being geometrically defined relative to Earth's surface. FIG. 4 depicts total fluid velocities 410 at many different points as arrows, with the arrows depicting the velocity direction and the length of the arrows depicting the relative magnitude of the velocity. Effects such as blockage, acceleration, and wash may be depicted by the arrows representing fluid velocities 410.

At 190, the planar fluid velocities may be transformed into two dimensions using the freestream fluid heading to yield a three-dimensional output of the fluid perturbation. The total planar velocity is transformed from the fluid reference frame to the Earth reference frame according to the following equations, with total velocity being a 1-to-1 translation:

$${u}_{earth} = {v}_{∞} [ 1 - {k}_{du} du ] * cos ( {flow}_{dir} ) positive , N to S flow$$

$${v}_{earth} = {v}_{∞} [ 1 - {k}_{du} du ] * sin ( {flow}_{dir} ) positive , E to W flow$$

$${w}_{earth} = {v}_{∞} [ {k}_{dw} dw ] positive , upward flow$$

The perturbations may be the difference of the total fluid flow velocities relative to the freestream velocity.

$${u}_{pert} = {u}_{earth} - {v}_{∞} * cos ( {flow}_{dir} ) positive , N to S flow$$

$${v}_{pert} = {v}_{earth} - {v}_{∞} * sin ( {flow}_{dir} ) positive , E to W flow$$

$${w}_{pert} = {w}_{earth} positive , upward flow$$

According to some aspects, data may be recorded and saved from the simulation. The data may include, but is not limited to, for example, perturbation results, terrain profile, and geometric doublet information. According to some aspects, the data may be in the form of a CSV file. According to some aspects, the data may be used for debugging or entered into a simulator debugging program. According to some aspects, the data may be written to a file, such as a CSV file, when called through the simulator debugging program.

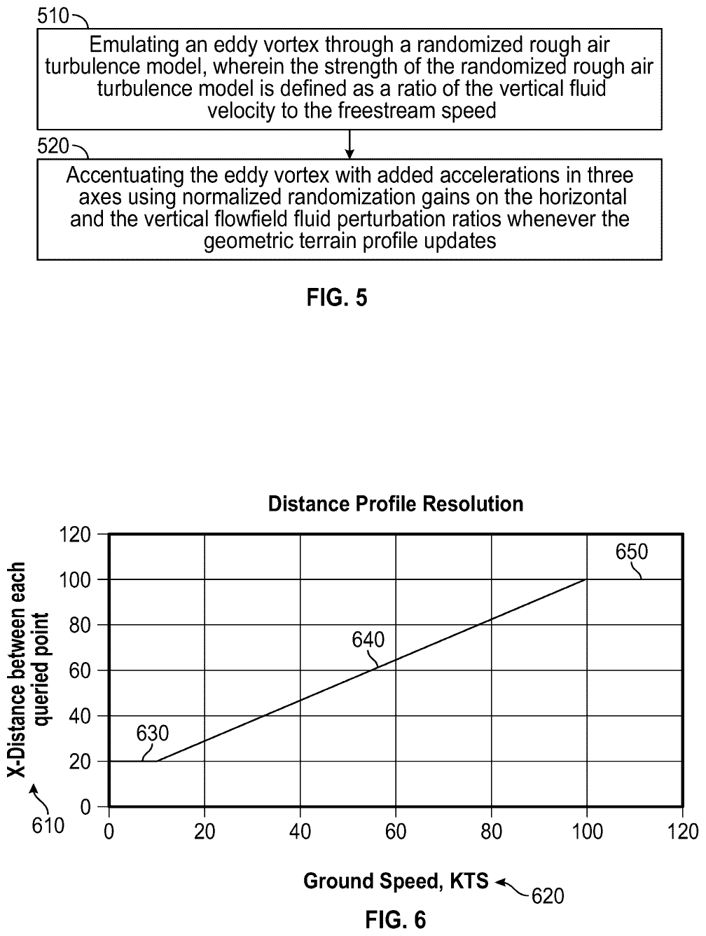

FIG. 5 depicts a process of further adding flowfield eddy vortex emulation to the simulation and analysis, according to some aspects. Potential flow theory does not provide eddy vortex results. Therefore, eddy vortex effects may be emulated through a randomized rough air turbulence model. At 510, eddy vortices may be emulated using a randomized rough air turbulence model, wherein the strength of the rough air turbulence model is defined as a ratio of the vertical fluid velocity to the freestream speed. The strength as a percentage is defined as the ratio of the vertical fluid perturbation velocity relative to the freestream speed, wₚₑᵣₜ/v₂₈*100. According to some aspects, the greater of a simulator's instructor operating station (IOS) selection or a calculated value is used to ensure fluid flow entrainment behavior and a blockage situation may be handled to impact any non-zero rough air turbulence selection on an IOS. According to some preferred aspects, the IOS rough air turbulence percentage selection value is decremented using: max (k_{du}du, 0)*100, which results in a percentage decrement only in a blockage scenario, and entrainment analysis is done on adjusted IOS values and the vertical fluid perturbation value to determine which to use for the vortex eddies.

At 520, the eddy vortices may be accentuated with added accelerations in three axes using normalized randomization gains on the horizontal and the vertical flowfield fluid perturbation ratios whenever the geometric terrain profile updates. Accelerations in the x and y directions may be provided by k_{du}du*rndₙᵤₘ and the z acceleration is provided by k_{dw}dw*rndₙᵤₘ.

According to some aspects, the two-dimensional simulated geometric terrain profile is defined by a distance profile resolution as a function of a ground speed of the simulated vehicle. FIG. 6 depicts a distance profile resolution 610 depending on ground speed 620 of the simulated vehicle. The ground speed of the simulated vehicle determines how quickly the two-dimensional simulated geometric terrain profile 210 is traversed. Because of limitations in computational power, only a limited number of points on the terrain profile 210 may be generated at a time. According to some aspects, a current visual query may only generate about 100 (x,z) points to represent the terrain profile 210 at approximately 2 Hz. However, enough distance must be analyzed when the simulated vehicle is moving fast to ensure proper fluid flow perturbations acting on the simulated vehicle at the analyzed time. Therefore, the distance profile resolution depicting a manageable number of points to analyze is evenly spaced along the x-axis for the distance needed to ensure proper fluid flow mechanics at a given time.

If the vehicle is moving quickly, the analysis points must be spaced further apart with a lower distance profile resolution than when the simulated vehicle is moving relatively slowly, in which case the profile resolution may be increased, resulting in a higher resolution of the terrain profile 210. Although increasing the profile resolution results in less distance being analyzed at a time due to the limited number of points gathered, it results in a more accurate depiction of flow conditions of terrain features and obstacles, such as cliffs or building edges. According to some aspects, as depicted in FIG. 6, the distance profile resolution 610 is set to query every 20 ft when the simulated vehicle is traveling at a ground speed 620 of 10 knots or lower at 630. In the example depicted in FIG. 6, the distance profile resolution is then linearly interpolated up to a maximum of capturing one point every 100 ft at 640, and continuing at that resolution at speeds past 100 knots at 650. These values may be preset inputs and may be changed by a TDM.

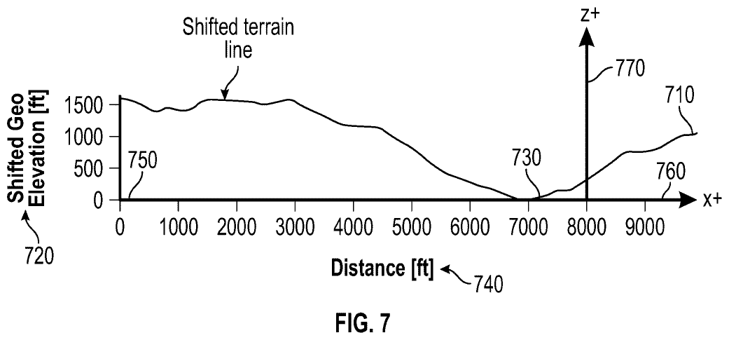

According to some aspects, the geometric terrain profile 210 is vertically shifted on the z-axis such that a lowest point of the geometric terrain profile 210 is at zero on the z-axis before packing doublets 240 under the geometric terrain line 210. FIG. 7 depicts the geometric terrain profile 210 of FIG. 2 shifted from the absolute geographic elevation 220 with a maximum elevation around 5000 ft in FIG. 2 to a shifted geographic elevation 720 with a maximum elevation around 1500 ft, with the lowest point 730 on the shifted geometric terrain profile 710 at 0 ft elevation.

To ensure that doublets 240 may be fully packed under the geometric terrain profile 210, a captured geometric terrain profile is vertically shifted by an offset value to initially received geometric terrain z-values. According to some aspects, the offset value is a preset value to the model, which may be changed by a TDM. According to some preferred aspects, a 3 ft shift is used as the offset value.

According to some aspects, the geometric terrain profile 210 is then shifted with its offset to set the lowest point 730 on the z-axis is set to a shifted geometric elevation 720 reference value of 0 ft. The terrain shift is done before packing doublets 240 under the geometric terrain profile 210 to ensure that no doublets 240 will be packed below the lowest point 730 of elevation while ensuring that doublets 240 may be packed under the entire geometric terrain profile 710.

According to some aspects, a calculation protection limit is set for a minimum allowed doublet radii and minimum elevation values on the z-axis. According to some aspects, the minimum allowed doublet radii may be changed by any TDM. According to some preferred aspects, the minimum allowed doublet radii is set to 1 ft. A minimum allowed elevation z-value is set to zero to ensure doublet packing protection. No doublets may be created below a zero point 730 of the z-axis.

With reference to FIG. 7, a slope of the simulated terrain profile 710 at each of a number of terrain points along the x-axis 740 according to some aspects. The slopes may be determined from a lowest x-value of the simulated terrain profile 710 at Xmin 750 through the second to greatest x-value at Xmax−1 760. If the calculated slope value is zero, it may be set to a minimum allowed slope magnitude of le-7 to for doublet packing algorithm protection to prevent divide by zero scenarios. The minimum allowed slope magnitude of 1e-7 complies with both 32-bit and 64-bit operating systems.

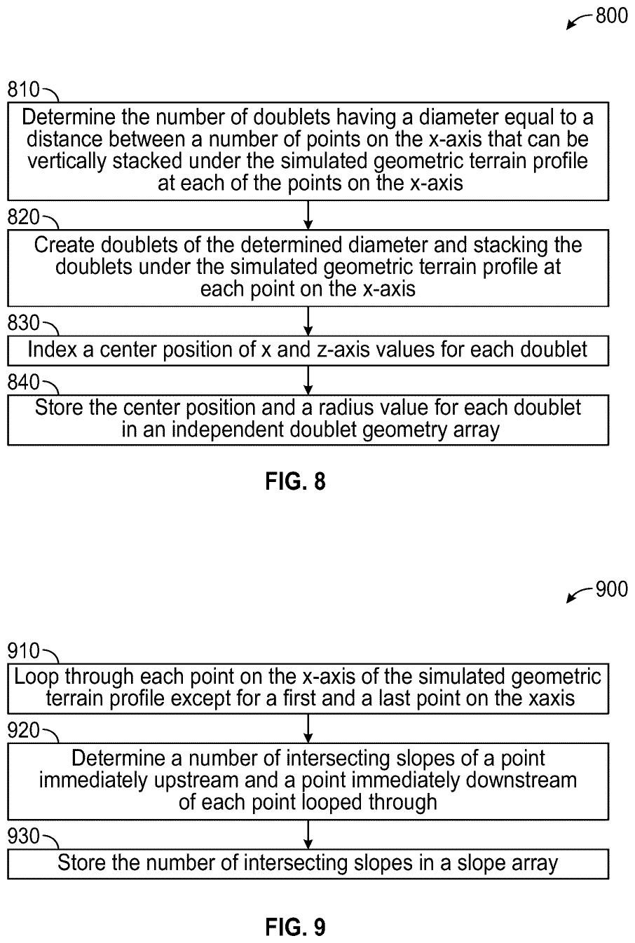

When packing doublets 240 under the simulated geometric terrain profile 710, the number of full-size doublets 240 that may be vertically packed on top of each other in the vertical z-axis 770 at each x-position along the x-axis 740 must be determined and packed under the simulated geometric terrain profile 710. FIG. 8 depicts a flowchart 800 of a process for packing a number of doublets 240 in the vertical z-axis 720 along the horizontal x-axis 740 under the two-dimensional simulated geometric terrain profile 710. At 810, a number of doublets 240 having a diameter equal to a distance between a number of points on the x-axis 740 that may be vertically stacked in the z-axis 770 under the simulated geometric terrain profile 710 at each of the points on the x-axis 740. At 820, the doublets 240 of the determined diameter may be created and stacked vertically in the z-axis 770 under the simulated geometric terrain profile 710. An example of vertically stacking a maximum number of doublets 240 under a simulated geometric terrain profile 210 at each point on an x-axis 250 is depicted in FIG. 2. At 830, a center position of x and z-axis values may be indexed for each doublet 240. Then, at 840, the center position and a radius value for each doublet 240 may be stored in an independent doublet geometry array.

To pack the full-size doublets 240 according to the flowchart 800, a loop may be performed from the minimum point on the x-axis 740 Xmin 750 to the second to greatest x-value at Xmax−1 760 at each x-position, analyzing a height in the z-axis 770 direction at each point on the x-axis 740 to determine which point has the shortest height. This process determines the number of full-size doublets 240 that may fit into a column stack at each x-point underneath the shifted geometric terrain profile 710. An example of a column stack is depicted in FIG. 2 by the geometric cylinder 230.

The first point on the x-axis 740 may be ignored when packing doublets 240 in stacks under the simulated geometric terrain profile 710. Ignoring the first point on the x-axis 740 may be visually depicted in FIG. 2 at 260. Doublets 240 may be packed in vertical stacks under the simulated geometric terrain profile 710 up to the second-to-last point Xmax−1 760 on the x-axis 740. The last index stack at the greatest x-value Xmax may be packed later using similar geometric analysis but may be performed independently because there is no x point beyond the maximum location point Xmax.

After packing the full-size doublets 240 under the terrain profile 710, all intersecting slopes of each point on the x-axis 740 of the terrain profile 710 may be determined. FIG. 9 depicts a flowchart 900 of a process for determining the intersecting slopes of each point on the x-axis 740 of the simulated geometric terrain profile 710. At 910, each point on the x-axis 740 may be looped through from the second-to-first x-point Xmin+1 through the second-to-last x-point Xmax−1 760. At 920, a number of intersecting slopes of a point immediately upstream and a point immediately downstream of each x-point looped through may be determined. At 930, the intersections of the slopes determined at 920 may be stored in a slope array.

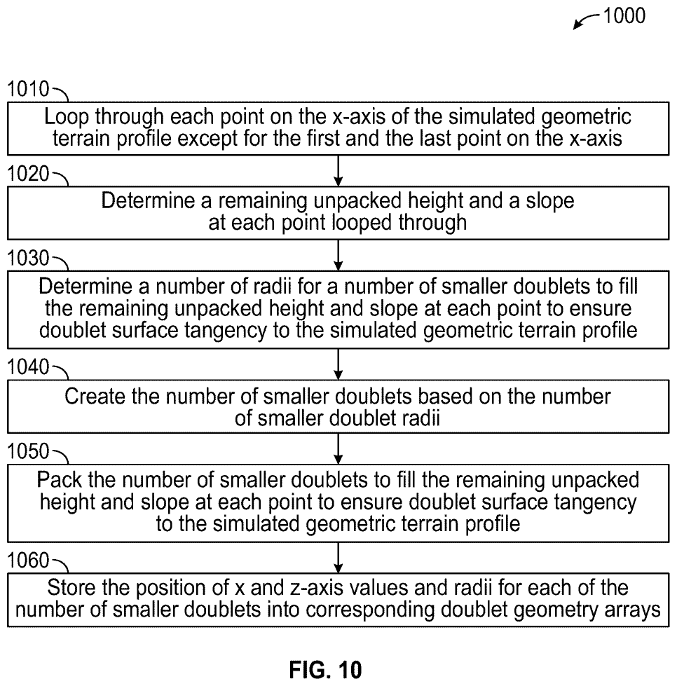

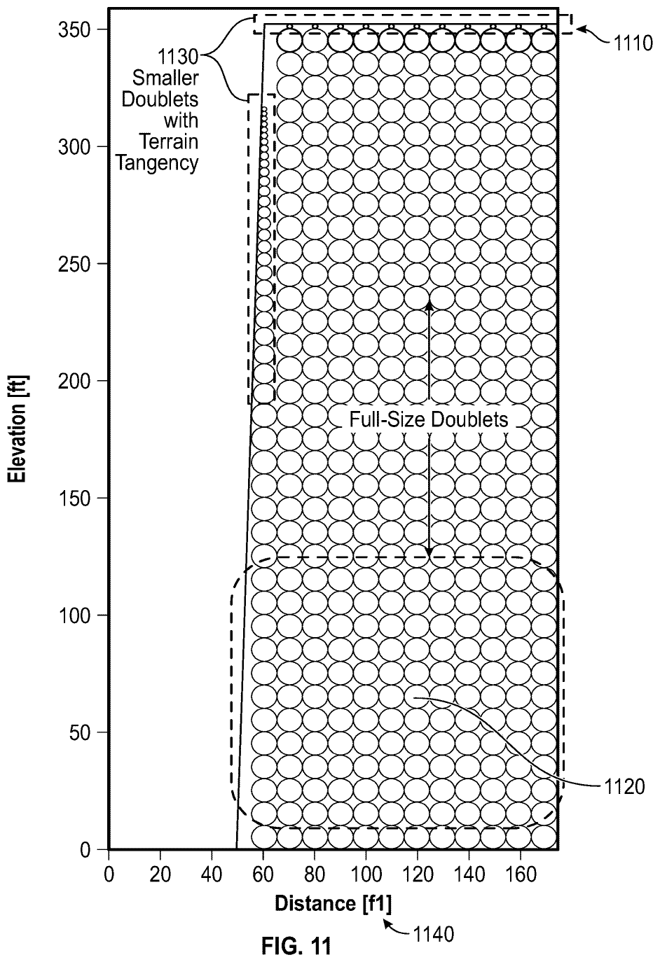

According to some aspects, smaller doublets may be packed in any remaining space under the simulated terrain profile 710 after it is packed with full-size doublets 240. FIG. 10 depicts a flowchart of a process for determining the size and number of the smaller doublets to pack in any remaining space under the simulated terrain profile 710 after it has been packed with full-size doublets 240. FIG. 11 depicts a simulated geometric terrain profile 1110 packed with full-size doublets 1120 with any remaining space packed with smaller doublets 1130. At 1010, each point on the x-axis 1140 of the simulated geometric terrain profile 1110 except for the first point and the last point on the x-axis 1140 may be looped through from Xmin+1 to Xmax−1. At 1020, any remaining unpacked height and slope between the simulated geometric terrain profile 1110 and the full-size doublets 1120 may be determined for each position on the x-axis 1140. At 1030, a number of radii for a number of smaller doublets 1130 to fill the remaining unpacked height and slope at each point to ensure doublet surface tangency to the simulated geometric terrain profile 1110 may be determined. At 1040, a number of the smaller doublets 1130 based on the number of smaller doublet radii may be created. At 1050, the number of smaller doublets 1130 to fill the remaining unpacked height and slope at each point to ensure doublet surface tangency to the simulated geometric terrain profile 1110 may be packed between the simulated geometric terrain profile 1110 and the full-size doublets 1120. Finally, at 1060, the position of x and z-axis values and radii for each of the number of smaller doublets 1130 may be stored into corresponding doublet geometry arrays.

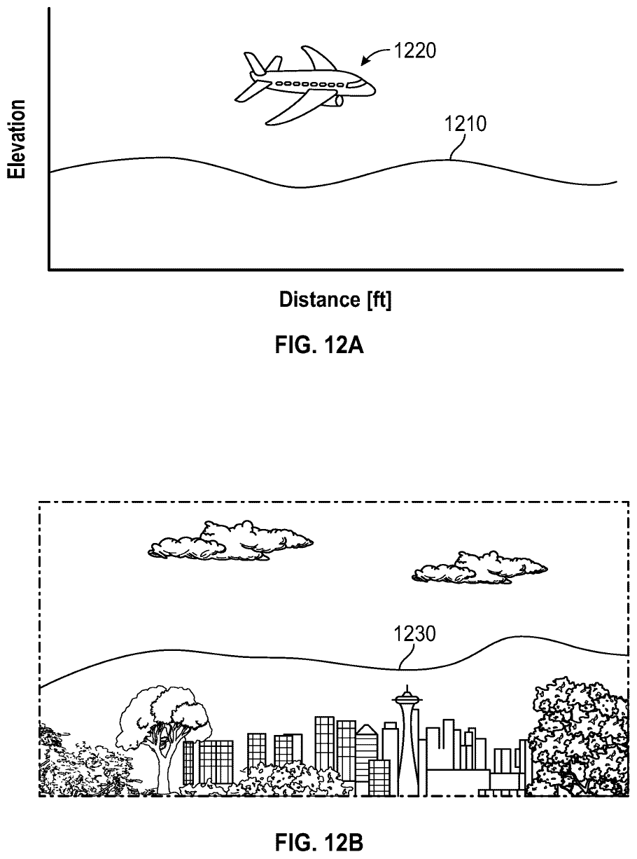

According to some aspects, the simulated terrain profile may be displayed on a monitor relative to the position of the simulated vehicle. FIGS. 12A-12B illustrate the geometric terrain profile displayed relative to the simulated vehicle. FIG. 12A depicts a third-person perspective view of a simulated geometric terrain profile 1210 relative to a simulated vehicle 1220 according to some aspects. FIG. 12B depicts a first-person view of a simulated geometric terrain 1230 relative to the simulated vehicle from the perspective of the simulated vehicle's cockpit according to some aspects. The first-person view depicted in FIG. 12B from the simulated vehicle's cockpit may be particularly useful for use in training simulators.

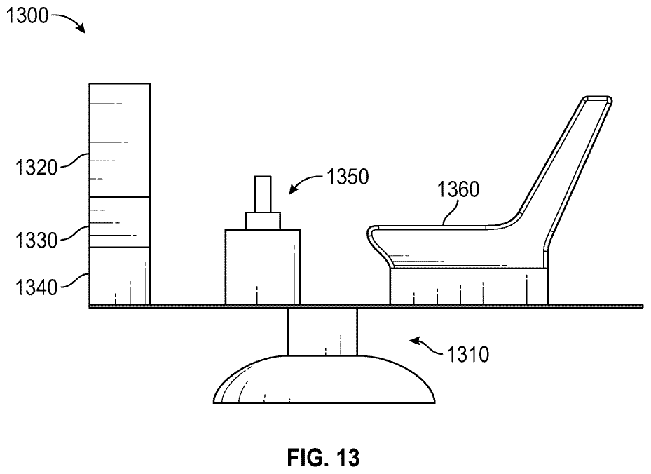

FIG. 13 depicts a simulator 1300 for a simulated vehicle in a fluid with a simulated terrain according to some aspects. Such simulators 1300 may be useful in training a user to operate the simulated vehicle. According to some aspects, feedback may be provided to the user by actuating an actuator 1310 on the simulator.

According to some aspects, a simulator 1300 comprises an electronic display 1320, a memory unit 1330 configured to store and execute a computer code configured to carry out the fluid perturbation simulation process, and a central processing unit 1340 configured to store and execute the computer code stored on the memory unit 1330 and output a result of the executed computer code on the electronic display 1320. The simulator 1300 may also include additional components to provide input or additional feedback to the user.

According to some aspects, the simulator outputs the result of the executed code stored on the memory unit 1330 and executed on the processing unit 1340 as a visual image of the simulated terrain relative to the simulated vehicle on the electronic display 1320. The image on the electronic display 1320 may be typically the first-person image shown in FIG. 12B to provide visual feedback to the user as if they were piloting the vehicle, which may be particularly useful for training purposes. However, other visual feedback may also be provided, including the third-person perspective of FIG. 12A.

According to some aspects, the simulator 1300 may also comprise an input device 1350 for a user to control a position and an orientation of the simulated vehicle relative to the simulated terrain. The simulator 1300 may also comprise a seat 1360 for a user to sit in while using the simulator. The user may provide input in real time through the input device 1350 to control the simulated vehicle and see the result of the user's input interacting with fluid dynamics of the simulated environment on the simulated vehicle on the electronic display 1320. This may be particularly useful for training the user to operate a vehicle being simulated with a high degree of realism by interacting with fluid flow conditions of the environment according to the processes described herein.

The simulator 1300 may comprise one or more actuators 1310 configured to move a user according to a position and an orientation of the simulated vehicle relative to the simulated terrain, according to some aspects. The actuator 1310 provides additional feedback to the user to make their experience more realistic, which may aid in training the user to experience how it feels to pilot the simulated vehicle when it is in different orientations and situations.

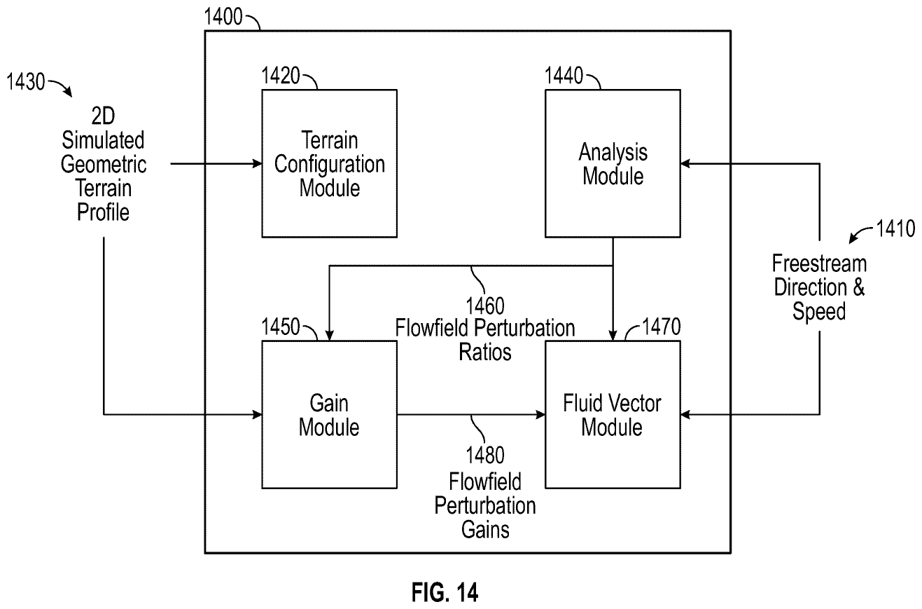

FIG. 14 depicts a system 1400 for determining interference effects on a fluid caused by a simulated geometric terrain profile and experienced by a simulated vehicle in real-time. The system 1400 receives a freestream direction and freestream speed 1410 for a simulated freestream of the fluid. The system 1400 comprises a terrain configuration module 1420 configured to receive a two-dimensional simulated geometric terrain profile 1430 having a horizontal x-axis and a vertical z-axis, and packing a number of geometric cylinders representing doublets in the vertical z-axis along the horizontal x-axis, as is depicted in FIG. 2.

The system 1400 also comprises an analysis module 1440 configured to determine an analysis point having an analysis x and analysis z position for a simulated vehicle relative to a reference position of the simulated vehicle using a defined x offset and z offset reference and an angular pitch attitude of the simulated vehicle along the freestream direction 1410 relative to the reference position, and determine a horizontal and a vertical flowfield fluid perturbation ratio 1460 at the analysis point along the x-axis and the z-axis.

The system 1400 also comprises a gain module 1450 configured to determine flow behavior conditions around the simulated vehicle and a positioning of the simulated vehicle relative to the simulated geometric terrain profile based on the flowfield perturbation ratios 1460 calculated in the analysis module 1440 and determine one or more flowfield fluid perturbation ratio gains 1480 based on the positioning of the simulated vehicle relative to the simulated geometric terrain profile 1430.

The system 1400 also comprises a fluid vector module 1470 configured to determine a total planar fluid velocity comprising the freestream speed 1410 and the horizontal flowfield fluid perturbation ratio 1460 and gain 1480 along the freestream direction 1410 and a total vertical fluid velocity comprising the vertical flowfield fluid perturbation ratio 1460 and gain 1480 along the z-axis and transform the planar fluid velocity into two dimensions.

According to some aspects, the horizontal and the vertical flowfield fluid perturbation ratios 1460 at the analysis point along the x-axis and the z-axis may be determined using potential flow theory.

According to some aspects, the fluid vector module 1470 may be further configured for emulating an eddy vortex through a randomized rough air turbulence model, wherein the strength of the randomized rough air turbulence model may be defined as a ratio of the vertical fluid velocity to the freestream speed 1410 and accentuating the eddy vortex with added accelerations in three axes using normalized randomization gains on the horizontal and the vertical flowfield fluid perturbation ratios 1460 whenever the geometric terrain profile 1430 updates.

According to some aspects, the two-dimensional simulated geometric terrain profile 1430 may be defined by a distance profile resolution as a function of ground speed of the simulated vehicle.

The method, simulator, and system described herein may be used to simulate a variety of vehicles over a variety of terrain and in a variety of fluids. This includes but is not limited to examples of vehicles in air, such as planes, helicopters, vertical takeoff and landing vehicles (VTOL), and gliders, as well as vehicles in liquid, such as submarines.

### Aspects of the Disclosure

The present disclosure is directed to the following aspects:

Aspect 1. A method for determining interference effects on a fluid caused by a simulated terrain profile and experienced by a simulated vehicle in real-time, comprising: receiving a freestream direction and a freestream speed for a simulated freestream of the fluid; receiving a two-dimensional simulated geometric terrain profile along the freestream direction having a horizontal x-axis and a vertical z-axis; packing a number of geometric cylinders as doublets in the vertical z-axis along the horizontal x-axis under the two-dimensional simulated geometric terrain profile; determining an analysis point having an analysis x and analysis z position for a simulated vehicle relative to a reference position of the simulated vehicle using a defined x offset and z offset reference and an angular pitch attitude of the simulated vehicle relative to the freestream direction; determining a flowfield fluid perturbation ratio at the analysis point along the x-axis and the z-axis; determining flow behavior conditions around the simulated vehicle and a positioning of the simulated vehicle relative to the simulated geometric terrain profile based on the flowfield fluid perturbation ratio; determining a flowfield fluid perturbation ratio gain based on the positioning of the simulated vehicle relative to the simulated geometric terrain profile; determining a total planar fluid velocity comprising the freestream speed and the flowfield fluid perturbation ratio and gain along the freestream direction and a total vertical fluid velocity comprising the flowfield fluid perturbation ratio and gain along the z-axis; and transforming the planar fluid velocity into two dimensions.

Aspect 2. The method according to aspect 1, wherein the flowfield fluid perturbation ratio at the analysis point along the x-axis and z-axis is determined using potential flow theory.

Aspect 3. The method according to aspect 1 or 2, further comprising: emulating an eddy vortex through a randomized rough air turbulence model, wherein the strength of the randomized rough air turbulence model is defined as a ratio of the vertical fluid velocity to the freestream speed; and accentuating the eddy vortex with added accelerations in three axes using randomization whenever the geometric terrain profile updates.

Aspect 4. The method according to any previous aspect, wherein the two-dimensional simulated geometric terrain profile is defined by a distance profile resolution as a function of a ground speed of the simulated vehicle.

Aspect 5. The method according to any previous aspect, further comprising implementing a defined vertical z-axis offset for the simulated geometric terrain profile by shifting the simulated geometric terrain profile so that a lowest point of the simulated geometric terrain profile is at zero on the z-axis.

Aspect 6. The method according to any previous aspect, further comprising setting calculation protection limits for minimum allowed doublet radii and minimum elevation values on the z-axis.

Aspect 7. The method according to any previous aspect, further comprising determining a slope of the simulated geometric terrain profile at each of a number of terrain points along the x-axis.

Aspect 8. The method according to any previous aspect, wherein the packing a number of doublets in the vertical z-axis along the horizontal x-axis under the two-dimensional simulated geometric terrain profile comprises: determining the number of doublets having a diameter equal to a distance between a number of points on the x-axis that may be vertically stacked under the simulated geometric terrain profile at each of the points on the x-axis; creating doublets of the determined diameter and stacking the doublets under the simulated geometric terrain profile at each point on the x-axis; indexing a center position of x and z-axis values for each doublet; and storing the center position and a radius value for each doublet in an independent doublet geometry array.

Aspect 9. The method according to aspect 8, further comprising: looping through each point on the x-axis of the simulated geometric terrain profile except for a first and a last point on the x-axis; determining a number of intersecting slopes of a point immediately upstream and a point immediately downstream of each point looped through; and storing the number of intersecting slopes in a slope array.

Aspect 9. The method according to aspect 9, further comprising: looping through each point on the x-axis of the simulated geometric terrain profile except for the first and the last point on the x-axis; determining a remaining unpacked height and a slope at each point looped through; determining a number of radii for a number of smaller doublets to fill the remaining unpacked height and slope at each point to ensure doublet surface tangency to the simulated geometric terrain profile; creating the number of smaller doublets based on the number of smaller doublet radii; packing the number of smaller doublets to fill the remaining unpacked height and slope at each point to ensure doublet surface tangency to the simulated geometric terrain profile; and storing the position of x and z-axis values and radii for each of the number of smaller doublets into corresponding doublet geometry arrays.

Aspect 10. The method according to any previous aspect, further comprising displaying the simulated geometric terrain profile relative to the position of the simulated vehicle on a monitor.

Aspect 11. The method according to any previous aspect, further comprising providing feedback to a user by actuating an actuator on a simulator.

Aspect 12: A non-transitory memory storing a set of instructions executable by a processor to perform the method according to any previous aspect.

Aspect 13: A method for determining interference effects on a fluid caused by a simulated terrain profile and experienced by a simulated vehicle in real-time, comprising: loading, by a processor, a freestream direction and a freestream speed for a simulated freestream of the fluid; loading, by the processor, a two-dimensional simulated geometric terrain profile along the freestream direction having a horizontal x-axis and a vertical z-axis; performing, by the processor, packing a number of doublets in the vertical z-axis along the horizontal x-axis under the two-dimensional simulated geometric terrain profile; determining, by the processor, an analysis point having an analysis x and analysis z position for a simulated vehicle relative to a reference position of the simulated vehicle using a defined x offset and z offset reference and an angular pitch attitude of the simulated vehicle relative to the freestream direction; determining, by the processor, a flowfield fluid perturbation ratio at the analysis point along the x-axis and the z-axis; determining, by the processor, flow behavior conditions around the simulated vehicle and a positioning of the simulated vehicle relative to the simulated geometric terrain profile based on the flowfield fluid perturbation ratio; determining, by the processor, a flowfield fluid perturbation ratio gain based on the positioning of the simulated vehicle relative to the simulated geometric terrain profile; determining, by the processor, a total planar fluid velocity comprising the freestream speed and the flowfield fluid perturbation ratio and gain along the freestream direction and a total vertical fluid velocity comprising the flowfield fluid perturbation ratio and gain along the z-axis; and transforming, by the processor, the planar fluid velocity into two dimensions.

Aspect 14: A computer implementation of the methods according to any previous aspect.

Aspect 15: A system embodying, in part, the computer implementation of aspect 13 or 14, wherein the system comprises at least a processor, a non-transitory computer-readable storage medium, and instructions stored on the non-transitory computer-readable storage medium for execution of the method by the processor.

Aspect 16: A simulator for simulation of movement of a vehicle in a fluid with a simulated terrain comprising an electronic display; a processor; a memory; and a computer code stored on the memory for execution by the processor of the method according to any one of aspects 1 to 11 and output a result of the executed computer code on the electronic display.

Aspect 17. The simulator according to aspect 16, wherein the result of the executed computer code output on the electronic display comprises a visual image of the simulated terrain relative to the simulated vehicle.

Aspect 18. The simulator according to aspect 16 or 17, further comprising an input device for a user to control a position and an orientation of the simulated vehicle relative to the simulated terrain.

Aspect 19. The simulator according to any one of aspects 16 to 18, further comprising a one or more actuators configured to move a user according to a position and an orientation of the simulated vehicle relative to the simulated terrain.

Aspect 20. A system for determining interference effects on a fluid caused by a simulated geometric terrain profile and experienced by a simulated vehicle in real-time, comprising a memory configured to receive a freestream direction and a freestream speed for a simulated freestream of the fluid; and software modules including: a terrain configuration module configured for receiving a two-dimensional simulated geometric terrain profile having a horizontal x-axis and a vertical z-axis, and packing a number of doublets in the vertical z-axis along the horizontal x-axis under the two-dimensional simulated geometric terrain profile; an analysis module configured for determining an analysis point having an analysis x and analysis z position for a simulated vehicle relative to a reference position of the simulated vehicle using a defined x offset and z offset reference and an angular pitch attitude of the simulated vehicle relative to the freestream direction, and determining a flowfield fluid perturbation ratio at the analysis point along the x-axis and the z-axis; a gain module configured for determining flow behavior conditions around the simulated vehicle and a positioning of the simulated vehicle relative to the simulated geometric terrain profile based on the flowfield fluid perturbation ratio, and determining a flowfield fluid perturbation ratio gain based on the positioning of the simulated vehicle relative to the simulated geometric terrain profile; and a fluid vector module configured for determining a total planar fluid velocity comprising the freestream speed and the flowfield fluid perturbation ratio and gain along the freestream direction and a total vertical fluid velocity comprising the flowfield fluid perturbation ratio and gain along the z-axis, and transforming the planar fluid velocity into two dimensions.

Aspect 21. The system of aspect 20, wherein the flowfield fluid perturbation ratio at the analysis point along the x-axis and z-axis is determined using potential flow theory.

Aspect 22. The system of aspect 20 or 21, wherein the fluid vector module is further configured for emulating an eddy vortex through a randomized rough air turbulence model, wherein the strength of the randomized rough air turbulence model is defined as a ratio of the vertical fluid velocity to the freestream speed and accentuating the eddy vortex with added accelerations in three axes using randomization whenever the geometric terrain profile updates.

Aspect 23. The system according to any one of aspects 20 to 22, wherein the two-dimensional simulated geometric terrain profile is defined by a distance profile resolution as a function of a ground speed of the simulated vehicle.

While specific aspects of the disclosure have been provided hereinabove, the disclosure may, however, be embodied in many different forms and should not be construed as necessarily being limited to only the aspects and embodiments disclosed herein. Rather, these embodiments may be provided so that this disclosure is thorough and complete, and fully conveys various concepts of this disclosure to skilled artisans.

Note that various terminology used herein may imply direct or indirect, full or partial, temporary or permanent, action or inaction. For example, when an element is referred to as being “on,” “connected” or “coupled” to another element, then the element may be directly on, connected or coupled to the other element or intervening elements may be present, including indirect or direct variants. In contrast, when an element is referred to as being “directly connected” or “directly coupled” to another element, there may be no intervening elements present.

Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others may be used herein to describe various elements, components, regions, layers, or sections, these elements, components, regions, layers, or sections should not necessarily be limited by such terms. Rather, these terms may be used to distinguish one element, component, region, layer, or section from another element, component, region, layer, or section. As such, a first element, component, region, layer, or section discussed below could be termed a second element, component, region, layer, or section without departing from this disclosure.

Also, unless otherwise defined, all terms (including technical and scientific terms) used herein have the same described herein may be better meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

As used herein, the term “and/or” includes any and all combinations of one or more of the associated listed items. Likewise, as used in the following detailed description, the term “or” is intended to mean an inclusive “or” rather than an exclusive “or.” That is, unless specified otherwise, or clear from context, “X employs A or B” is intended to mean any of the natural inclusive permutations. Thus, if X employs A; X employs B; or X employs both A and B, then “X employs A or B” is satisfied under any of the foregoing instances.

All numerical quantities stated herein may be approximate, unless stated otherwise. Accordingly, the term “about” may be inferred when not expressly stated. The numerical quantities disclosed herein may be to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values may be reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

The terminology used herein is for the purpose of describing particular examples only and is not intended to be limiting. As used herein, the singular forms “a”, “an”, and “the” may be intended to include the plural forms as well, unless the context clearly indicates otherwise. As example, “a” two-dimensional simulated geometric terrain profile may comprise one or more profiles, and the like.

The terms “comprises”, “comprising”, “including”, “having”, and “characterized by”, may be inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, described herein also specifically includes embodiments consisting of, or consisting essentially of, such recited compositions, materials, components, elements, features, integers, operations, and/or process steps. In the case of “consisting of”, the alternative embodiment excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics may be excluded from such an embodiment, but any compositions, materials, components, elements, features, integers, operations, and/or process steps that do not materially affect the basic and novel characteristics may be included in the embodiment.

Any method steps, processes, and operations described herein may be not to be construed as necessarily requiring their performance in the particular order discussed or illustrated, unless specifically identified as an order of performance. It is also to be understood that additional or alternative steps may be employed, unless otherwise indicated.

In addition, features described with respect to certain example embodiments may be combined in or with various other example embodiments in any permutational or combinatory manner. Different aspects or elements of example embodiments, as disclosed herein, may be combined in a similar manner. The term “combination”, “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) may be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards may be just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure may be described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

Words such as “then,” “next,” etc. are not intended to limit the order of the steps; these words may be simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, may be at least partially performed via at least one entity or actor in any manner.

All documents cited herein may be incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that may be within the scope of this application.

1. A computer-implemented method for determining interference effects on a fluid caused by a simulated terrain profile and experienced by a simulated vehicle in real-time, comprising:
receiving a freestream direction and a freestream speed for a simulated freestream of the fluid;
receiving a two-dimensional simulated geometric terrain profile along the freestream direction having a horizontal x-axis and a vertical z-axis;
packing a number of geometric cylinders representing doublets in the vertical z-axis along the horizontal x-axis under the two-dimensional simulated geometric terrain profile;
determining an analysis point having an analysis x and analysis z position for a simulated vehicle relative to a reference position of the simulated vehicle using a defined x offset and z offset reference and an angular pitch attitude of the simulated vehicle along the freestream direction relative to the reference position;
determining a horizontal and a vertical flowfield fluid perturbation ratio at the analysis point along the x-axis and the z-axis;
determining flow behavior conditions around the simulated vehicle and a position of the simulated vehicle relative to the simulated geometric terrain profile based on the horizontal and the vertical flowfield fluid perturbation ratios;
determining one or more flowfield fluid perturbation ratio gains based on the position of the simulated vehicle relative to the simulated geometric terrain profile;
determining a total planar fluid velocity comprising the freestream speed and the horizontal flowfield fluid perturbation ratio and gain along the freestream direction and a total vertical fluid velocity comprising the vertical flowfield fluid perturbation ratio and gain along the z-axis; and
transforming the planar fluid velocity into two dimensions.

2. The computer-implemented method of claim 1, wherein the horizontal and the vertical flowfield fluid perturbation ratios at the analysis point along the x-axis and z-axis is determined using potential flow theory.

3. The computer-implemented method of claim 1, further comprising:
emulating an eddy vortex through a randomized rough air turbulence model, wherein the strength of the randomized rough air turbulence model is defined as a ratio of the vertical fluid velocity to the freestream speed; and
accentuating the eddy vortex with added accelerations in three axes using normalized randomization gains on the horizontal and the vertical flowfield fluid perturbation ratios whenever the geometric terrain profile updates. cm 4. The computer-implemented method of claim 1, wherein the two-dimensional simulated geometric terrain profile is defined by a distance profile resolution as a function of a ground speed of the simulated vehicle.

5. The computer-implemented method of claim 1, further comprising implementing a defined vertical z-axis offset for the simulated geometric terrain profile by shifting the simulated geometric terrain profile so that a lowest point of the simulated geometric terrain profile is at zero on the z-axis.

6. The computer-implemented method of claim 1, further comprising setting calculation protection limits for minimum allowed doublet radii and minimum elevation values on the z-axis.

7. The computer-implemented method of claim 1, further comprising determining a slope of the simulated geometric terrain profile at each of a number of terrain points along the x-axis.

8. The computer-implemented method of claim 1, wherein the packing a number of doublets in the vertical z-axis along the horizontal x-axis under the two-dimensional simulated geometric terrain profile comprises:
determining the number of doublets having a diameter equal to a distance between a number of points on the x-axis that may be vertically stacked under the simulated geometric terrain profile at each of the points on the x-axis;
creating doublets of the determined diameter and stacking the doublets under the simulated geometric terrain profile at each point on the x-axis;
indexing a center position of x and z-axis values for each doublet; and
storing the center position and a radius value for each doublet in an independent doublet geometry array.

9. The computer-implemented method of claim 8, further comprising:
looping through each point on the x-axis of the simulated geometric terrain profile except for a first and a last point on the x-axis;
determining a number of intersecting slopes of a point immediately upstream and a point immediately downstream of each point looped through; and
storing the number of intersecting slopes in a slope array.

10. The computer-implemented method of claim 9, further comprising:
looping through each point on the x-axis of the simulated geometric terrain profile except for the first and the last point on the x-axis;
determining a remaining unpacked height and a slope at each point looped through;
determining a number of radii for a number of smaller doublets to fill the remaining unpacked height and slope at each point to ensure doublet surface tangency to the simulated geometric terrain profile;
creating the number of smaller doublets based on the number of smaller doublet radii;
packing the number of smaller doublets to fill the remaining unpacked height and slope at each point to ensure doublet surface tangency to the simulated geometric terrain profile; and
storing the position of x and z-axis values and radii for each of the number of smaller doublets into corresponding doublet geometry arrays.

11. The computer-implemented method of claim 1, further comprising displaying the simulated geometric terrain profile relative to the position of the simulated vehicle on a monitor.

12. The computer-implemented method of claim 1, further comprising providing feedback to a user by actuating an actuator on a simulator.

13. A simulator for a simulated vehicle in a fluid with a simulated terrain according to the process of claim 1 comprising:
an electronic display;
a memory unit configured to store and execute a computer code configured to carry out the process of claim 1; and
a central processing unit configured to execute the computer code stored on the memory unit and output a result of the executed computer code on the electronic display.

14. The simulator of claim 13, wherein the result of the executed computer code output on the electronic display comprises a visual image of the simulated terrain relative to the simulated vehicle.

15. The simulator of claim 13, further comprising an input device for a user to control a position and an orientation of the simulated vehicle relative to the simulated terrain.

16. The simulator of claim 13, further comprising a one or more actuators configured to move a user according to a position and an orientation of the simulated vehicle relative to the simulated terrain.

17. A system for determining interference effects on a fluid caused by a simulated geometric terrain profile and experienced by a simulated vehicle in real-time, comprising:
a memory configured for receiving-a freestream direction and a freestream speed for a simulated freestream of the fluid;
a terrain configuration module configured for receiving a two-dimensional simulated geometric terrain profile having a horizontal x-axis and a vertical z-axis, and packing a number of geometric cylinders representing doublets in the vertical z-axis along the horizontal x-axis under the two-dimensional simulated geometric terrain profile;
an analysis module configured for determining an analysis point having an analysis x and analysis z position for a simulated vehicle relative to a reference position of the simulated vehicle using a defined x offset and z offset reference and an angular pitch attitude of the simulated vehicle along the freestream direction relative to the reference position, and determining a horizontal and a vertical flowfield fluid perturbation ratio at the analysis point along the x-axis and the z-axis;
a gain module configured for determining flow behavior conditions around the simulated vehicle and a positioning of the simulated vehicle relative to the simulated geometric terrain profile based on the flowfield fluid perturbation ratios, and determining one or more flowfield fluid perturbation ratio gains based on the positioning of the simulated vehicle relative to the simulated geometric terrain profile; and
a fluid vector module configured for determining a total planar fluid velocity comprising the freestream speed and the horizontal flowfield fluid perturbation ratio and gain along the freestream direction and a total vertical fluid velocity comprising the vertical flowfield fluid perturbation ratio and gain along the z-axis, and transforming the planar fluid velocity into two dimensions.

18. The system of claim 17, wherein the horizontal and the vertical flowfield fluid perturbation ratios at the analysis point along the x-axis and z-axis is determined using potential flow theory.

19. The system of claim 17, wherein the fluid vector module is further configured for emulating an eddy vortex through a randomized rough air turbulence model, wherein the strength of the randomized rough air turbulence model is defined as a ratio of the vertical fluid velocity to the freestream speed and accentuating the eddy vortex with added accelerations in three axes using normalized randomization gains on the horizontal and the vertical flowfield fluid perturbation ratios whenever the geometric terrain profile updates.

20. The system of claim 17, wherein the two-dimensional simulated geometric terrain profile is defined by a distance profile resolution as a function of a ground speed of the simulated vehicle.
